(19) United States
(12) Patent Application Publication
(10) Pub. No.: US 2019/0057376 A1
(43) Pub. Date: Feb. 21, 2019

(54) SYSTEM AND METHOD FOR FACILITATING ACCESS AND PAYMENTS TO A PARKING FACILITY

(71) Applicant: Parq Corporation, Miami, FL (US)

(72) Inventor: Manuel Perez-Tamayo, Miami, FL (US)

(73) Assignee: Parq Corporation, Miami, FL (US)

(21) Appl. No.: 16/104,795

(22) Filed: Aug. 17, 2018

Related U.S. Application Data
(60) Provisional application No. 62/547,095, filed on Aug. 17, 2017.

(51) Int. Cl. G06Q 20/32; G06Q 50/30; G06K 7/10

(52) U.S. Cl. CPC G06Q 20/3278; G06K 7/10297; G06Q 50/30

(57) ABSTRACT

A system and method facilitates access and payment to a parking facility. The vehicle operator/owner downloads a software application and inputs personal and financial information during registration. The personal and financial information is stored in a parking facility server and a payment server. The system generates an electronic ticket, or a radio frequency identification technology, or Bluetooth networking standard that correspond to the personal and financial information. A reader at the gate controller, in the parking area, scans the electronic ticket or RFID from the mobile communication device or vehicle. The server authorizes the gate controller to enable access for the vehicle to a parking area, based on the information. When the vehicle egresses the parking area, the electronic ticket or RFID is scanned again, and the duration in the parking area is transmitted to payment server to process payment and provide a receipt based on duration in parking area.

### CROSS REFERENCE OF RELATED APPLICATION

This application claims the benefit and priority of U.S. provisional application No. 62/547,095 filed Aug. 17, 2017, entitled SYSTEM AND METHOD FOR FACILITATING ACCESS AND PAYMENTS TO A PARKING FACILITY, the entirety of which is incorporated herein by reference.

### FIELD OF THE INVENTION

The present invention relates generally to a system and method for facilitating access and payments to a parking facility, and, more particularly, relates to a system and method that facilitates access and payment to a parking facility by registering a user to obtain personal and financial information from the user and using an electronic ticket, a radio frequency identification technology, or Bluetooth networking standard to communicate the user information with a gate controller that regulates access to the user's vehicle to a parking area, and a payment server that processes payment for the duration the vehicle is in the parking area.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known that in urban environments, drivers have to cruise up and down streets trying to find a parking space near their destinations. This is time-consuming, inefficient and wasteful. Drivers seeking parking spaces may deliberately modify their times of arrival or departure in order to account for the need to find an available parking space. Often, a public or private parking lot that charges a fee for the duration of parking is a preferable option to parking in the street.

Generally, parking in a public or private lot involves the vehicle driving to a parking area, collecting a time stamp card, and then upon egressing the parking area, paying an attendant for the duration of time parked therein. In more automated systems, after the vehicle arrives to the parking lot, or another parking space, the user pays for parking by a telephone through the existing credit payment systems, instead of manually with coins.

Typically, in these systems, the driver does not know in advance whether there is a parking space for his vehicle at the parking lot or at the street that he is driving to. The driver may arrive at the parking lot or to his destination, only to discover that there are no empty parking spaces, and that he cannot park his vehicle there.

Other proposals have involved automated parking systems. The problem with these parking systems is that they do not provide the option of driving straight through the gate controller by merely scanning an electronic ticket on a smart phone, or an RFID tag affixed to the windshield of the vehicle. Also, they do not collect the personal and financial information of the vehicle operator/owner, and use this to enable access to the parking lot, and automate payments. Even though the above cited parking systems meet some of the needs of the market, a system and method that facilitates access and payment to a parking facility by registering a user to obtain personal and financial information from the user and using an electronic ticket, a radio frequency identification technology, or Bluetooth networking standard to communicate the user information with a gate controller that regulates access to the user's vehicle to a parking area, and a payment server that processes payment for the duration the vehicle is in the parking area, is still desired.

### SUMMARY OF INVENTION

Illustrative embodiments of the disclosure are generally directed to a system and method for facilitating access and payments to a parking facility. The system and method serves to facilitate access and payment to a parking facility by registering a user through a software application, and collecting the collected personal and financial information in a parking facility server and a payment server. The system and method generates an electronic ticket, a radio frequency identification technology, or Bluetooth networking standard that correspond to the personal and financial information. The parking facility server communicates the user information with a gate controller. A reader at the gate controller scans the electronic ticket or RFID from the mobile communication device or vehicle. The server authorizes the gate controller to enable access for the vehicle to a parking area. A payment server is in communication with the gate controller to process payment based on the duration of use of the parking area

In one non-limiting embodiment, computer-implemented method for facilitating access and payments to a parking facility, comprises the steps of: providing a parking facility having a parking area for parking a vehicle; providing a software application operable on a mobile communication device; registering a user through the software application, the registration including providing contact information, vehicle type, payment preferences, and a password; inputting personal and financial information through the software application.

Additional steps include communicating the personal and financial information from the software application to a parking facility server, the parking facility server storing the personal and financial information; providing a payment server, the payment server being in communication with the parking facility server; generating an electronic ticket or a radio frequency identification, the electronic ticket and the radio frequency identification corresponding to the personal and financial information; displaying the electronic ticket and the radio frequency identification on the mobile communication device, or the vehicle, or both; providing a gate controller to regulate access to the parking area, the gate controller comprising a gate, the gate controller being in communication with the parking facility server, the gate controller being operatively connected to a reader, the reader being operable to read the electronic ticket and the radio frequency identification.

Yet more steps comprise reading directly, with the reader, the electronic ticket or the radio frequency identification through the mobile communication device or the vehicle; relaying, by the gate controller, the personal and financial information to the parking facility server; authorizing, by the parking facility server, passage of the vehicle to and from the parking area, whereby the gate controller actuates a gate to enable passage; processing, with the payment server, a payment for the duration in the parking area, the payment based at least partially on the duration that the vehicle is in the parking area and actuation of the gate by the gate controller; and displaying, by the software application, a historical archive of prior parking payments and parking durations.

In accordance with another feature, an embodiment of the present invention includes an additional step of providing a payment server, the payment server being in communication with the parking facility server.

In accordance with a further feature of the present invention, the step of processing the payment, further comprises, processing, with the payment server, a payment for the duration in the parking area, the payment based at least partially on the duration that the vehicle is in the parking area and actuation of the gate by the gate controller.

In accordance with a further feature of the present invention, the method comprises an additional step of storing the personal and financial information in a remote database.

In accordance with a further feature of the present invention, the method comprises an additional step of registering a user through the software application, the registration including providing contact information, vehicle type, payment preferences, and a password.

In accordance with a further feature of the present invention, the method comprises an additional step of displaying, by the software application, a historical archive of prior parking payments and parking durations.

In accordance with a further feature of the present invention, the electronic ticket and the radio frequency identification comprises a QR code.

In accordance with a further feature of the present invention, the reader is a scanner.

In accordance with a further feature of the present invention, the reader comprises an NFC reader.

In accordance with a further feature of the present invention, the mobile communication device is an NFC-enabled mobile communication device.

In accordance with a further feature of the present invention, the mobile communication device includes at least one of the following: a smart phone, a tablet, a laptop, and a computer.

In accordance with a further feature of the present invention, the parking facility server includes at least one of the following: a cloud, a server, a database, a network, and a processor.

In accordance with a further feature of the present invention, the radio frequency identification is a Passive High Frequency or an Ultra High Frequency RFID tag.

One objective of the present invention is to automate and streamline user access and payment transactions at a parking facility, so as to enable a vehicle to enter and exit the parking area more efficiently, while also paying for the parking service in an expedited manner.

Another objective is to automate payments for duration of use in a parking area.

Yet another objective is to allow a vehicle to quickly pass through a gate controller by scanning an electronic ticket on a smart phone, or an RFID affixed opt a windshield.

Yet another objective is to securely store the personal and financial information of a user, vehicle owner, vehicle operator.

Yet another objective is to provide a user application for the vehicle, a parking facility application for an administrator of the parking area, and a Web application.

Yet another objective is to provide Bluetooth and NFC technologies for transfer of data and approving of payments and opening the gate.

Yet another objective is to provide an easy to operate system and method for accessing a parking facility.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of an exemplary for facilitating access and payments to a parking facility, in accordance with the present invention;

FIG. 2 is a flowchart of an exemplary method for facilitating access and payments to a parking facility, in accordance with the present invention;

FIG. 3 illustrates a mobile device software application, showing menu pages for functions and options, in accordance with the present invention;

FIG. 4 illustrates a scanner page for the mobile software application of FIG. 3, in accordance with the present invention;

FIG. 5 illustrates various menu options for the mobile software application of FIG. 3, in accordance with the present invention;

FIG. 6 illustrates a tablet device software application, showing menu pages for functions and options, in accordance with the present invention;

FIG. 7 illustrates a top view of an exemplary RFID tag for a vehicle, showing a substrate, a chip, and an antenna coil, in accordance with the present invention;

FIG. 8 illustrates an RFID fob, in accordance with the present invention;

FIG. 9 illustrates an RFID transponder, in accordance with the present invention;

FIGS. 10A and 10B are perspective views of an exemplary vehicle entering and exiting a parking area at a gate controller, where FIG. 10A shows the vehicle entering, and FIG. 10B shows the vehicle exiting, in accordance with the present invention;

FIG. 11 is a flowchart of an alternative method for a payment process at a parking facility, in accordance with the present invention;

FIG. 12 is a block diagram showing the relationship between a reader, a mobile communication device, and a payment server, in accordance with the present invention; and

FIG. 13 is a block diagram showing an alternative relationship between a reader, an RFID transponder device, and a payment server, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient system 100 and method 200 for facilitating access and payments to a parking facility 102. Embodiments of the invention provide a system 100 and method 200 that facilitates access and payment to a parking facility 102 by allowing a vehicle 114, or owner/operator of the vehicle, to register through a software application. The registration includes providing personal information, financial information, contact information, payment preferences, and a password. The information is pertinent to use of the parking facility 102. A parking facility server 118 receives and stores the information.

An electronic ticket 120 (or “e-ticket”) or radio frequency identification tag 126 (RFID) that corresponds to the information is then generated. The electronic ticket 120 and/or the RFID tag 126 is scanned at a gate controller 106. The corresponding information is transmitted to the parking facility server 118, which communicates with a gate controller 106 to enable or restrict access to the parking area 104. NFC-enabled devices may also be used in the data communications. Though in other embodiments, the personal and financial information may be communicated through Bluetooth networking standard 124. The gate controller 106 is connected through a network to communicate with the payment server 122, the facility server 118, and the gate 108

System 100 provides a reader 110 to scan the electronic ticket 120 and/or RFID tag 126 at the gate controller 106 of the parking area 104. The reader can include: a barcode scanner 110, an RFID scanner 110, a smart phone scanner, and a Bluetooth/RFID receiver 112.

A payment server 122 processes payment for use of the parking area 104 based, at least partially, on the duration of time the user is in a parking area 104 and/or the number of times the parking area 104 is accessed by the vehicle 114, i.e. a deployable gate 108 is raised and lowered. The payment server 122 calculates payment by the vehicle 114 for accessing the parking area 104 during the duration of time. The payment server 122 also generates an electronic receipt to the vehicle 114 after use of the parking facility 102 to record the parking transactions.

Said another way, a system 100 facilitates in providing customer service for a parking facility/garage, employing user interfaces and devices that enable payment and access to a parking facility/garage. The system 100 provides a software application used in association with parking garage. The garage comprises a gate activated by an e-ticket, or bar code that is generated on a user's phone. The user can pay at the gate or in advance for the e-ticket. The user can register for the garage and has access thereto based on a unique user code generated by the software for the e-ticket and uniquely read by the garage. The software may also utilize a Bluetooth/RFID option that can communicate when the user approaches the gate and opens and closes the gate in advance of the user approaching or leaving the gate.

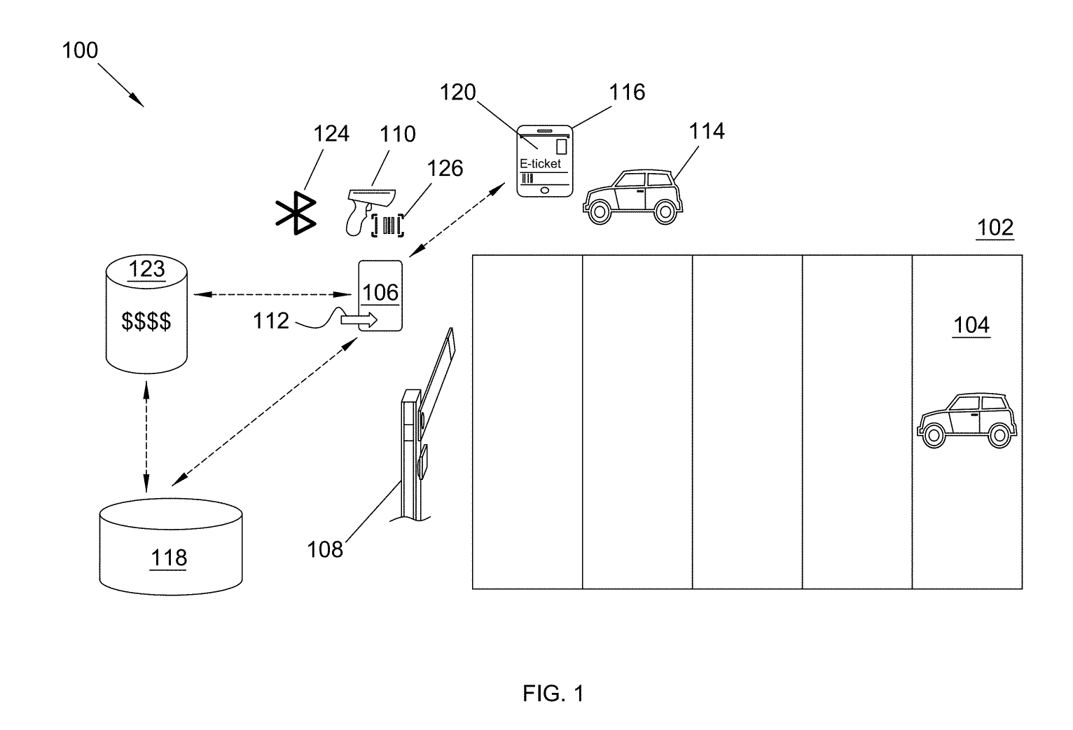

FIG. 1 shows several advantageous features of the present invention, but, as will be described below, the invention can be provided in several shapes, sizes, combinations of features and components, and varying numbers and functions of the components. The first example of a system 100 for facilitating access and payments to a parking facility, as shown in FIG. 1, includes a system 100 that is configured to automate and streamline user access and payment transactions at a parking facility 102. This allows the vehicle 114 to enter and exit the parking area 104 more efficiently, while also paying for the parking service in an expedited manner.

In one embodiment, the system 100 provides a software application that is used in association with a parking facility 102. The software application is downloadable by a vehicle 114 on a mobile communication device 116, such as a smart phone, tablet, laptop, and the like. The mobile communication device 116 is configured to be carried by the vehicle 114 while parking. The mobile communication device is operable to communicate user information with the system 100 for gaining access to the parking area 104, and paying for use of the parking area 104.

It is significant to note that the terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

The software application from the above description can also be accessed through a simple company webpage in the Internet. Users may purchase the aforementioned RFID tag 126 and register their individual device on any laptop, desktop, or mobile browser.

The parking facility 102 may include, without limitation, a general vehicle parking area, a parking garage, a parking lot, a boat dock, an airport, and animal stalls. The parking facility 102 charges a fee to allow a vehicle 114 to park in a parking area 104 for a duration. An automated or manned gate 108 regulates access to the parking area 104. A payment server 122 calculates charges to the vehicle 114 for the duration of parking.

Through the software application, the vehicle 114 registers personal and financial information with a parking facility server 118. The user's provided personal and financial information may include, without limitation, a name, a vehicle type, a license plate number, an address, a phone number, a work place, and a credit card number. The information is stored on both the mobile communication device 116 of the vehicle 114, and the parking facility server 118. The personal and financial nature of the vehicle 114 information allows the system 100 to communicate with the parking facility 102 for authorizing vehicle 114 access to a parking area 104, and processing payment for parking in the parking area 104.

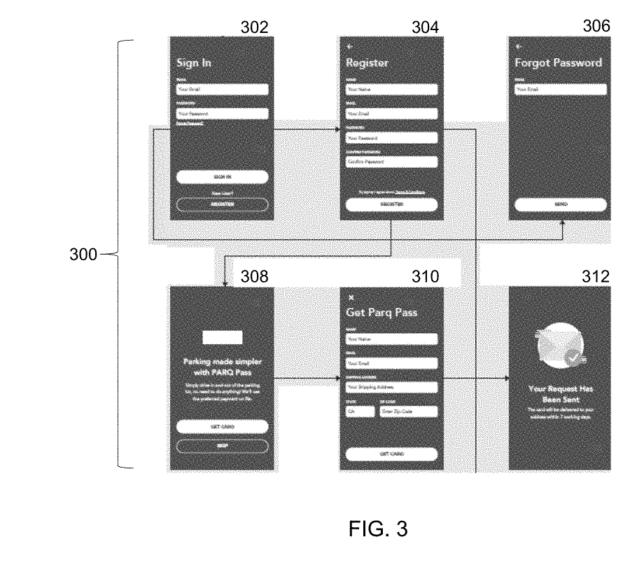

The software application represents the front end of the system. In one embodiment, the system provides a user mobile application 300 that is operable from a smart phone, as shown in FIGS. 3-5. The user mobile application 300 is regulated and controlled by users, such as vehicle owners and vehicle operators. The user mobile application communicates with the parking facility server, or payment server, or remote database to link payment information, show QR code, and view transaction history.

As discussed above, and shown in FIG. 3, the vehicle operator/owner downloads the mobile application 300. After downloading the mobile application 300, the user signs in through a sign-in page 302. This can include providing a name and password. The user may then register on a registration page 304 to provide personal information, financial information, contact information, payment preferences, and a password. If the user should forget a password, a password recollection page 306 allows the user to recover the forgotten password. This may be through an email or text to the user; whereby the user creates a new password.

Continuing with FIG. 3, the user can next obtain the electronic ticket 120 or RFID tag 126 from an identification obtainment page 308. The user has provided the personal and financial information, along with other information. The electronic ticket 120 or RFID tag 126 correspond to, and display this information upon being scanned by an appropriate reader/scanner. A shipping page 310 allows the user to provide a mailing address to receive the RFID tag 126. However, the electronic ticket 120 does not require shipping, since it is simply downloaded on the mobile device. A verification page 312 indicates that the shipping request has been sent, and the RFID tag 126 is being shipped to the user. Once the user receives the RFID tag 126, it is affixed to the vehicle windshield, at a location that is easily scanned by the reader 110 at the gate controller 106.

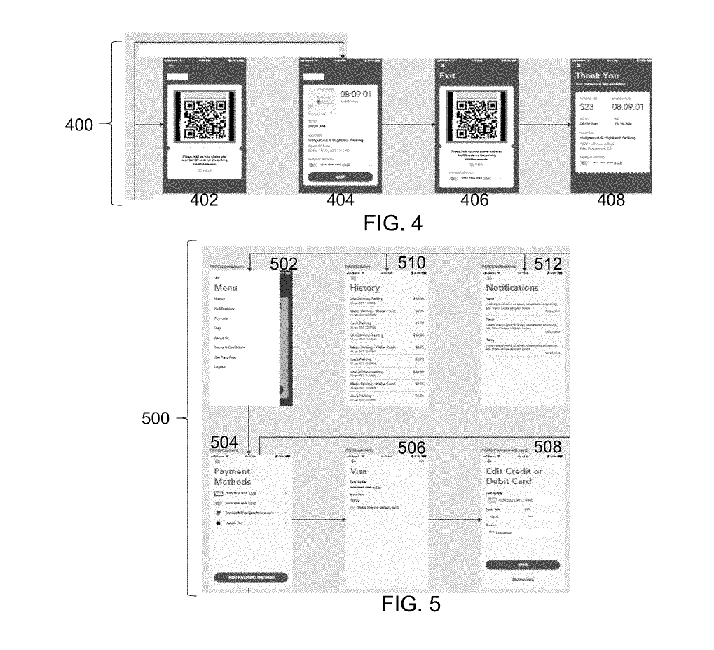

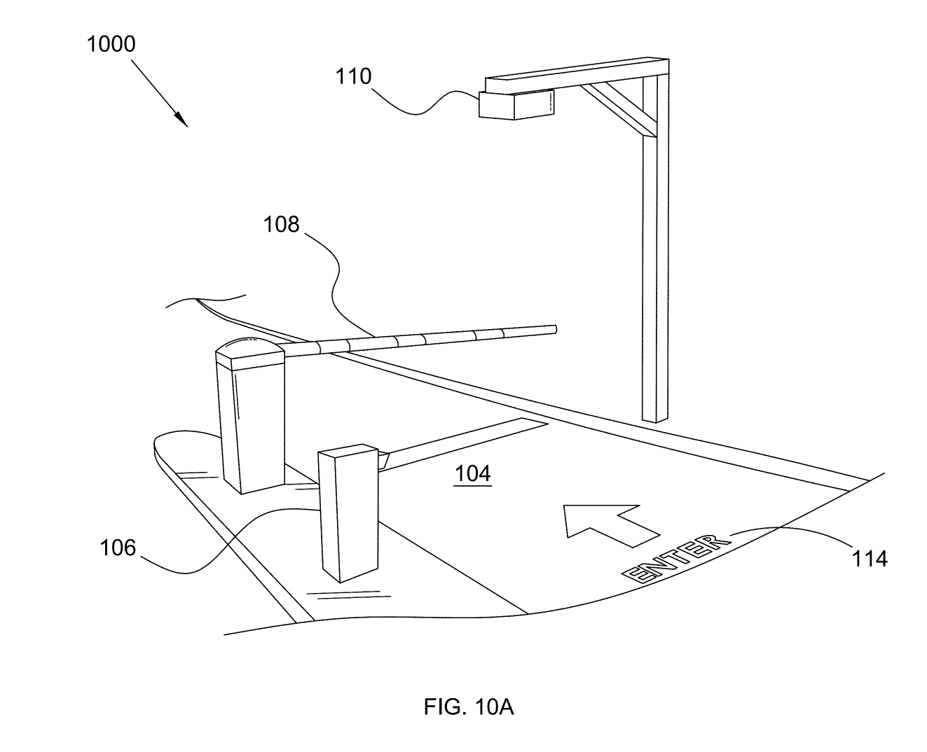

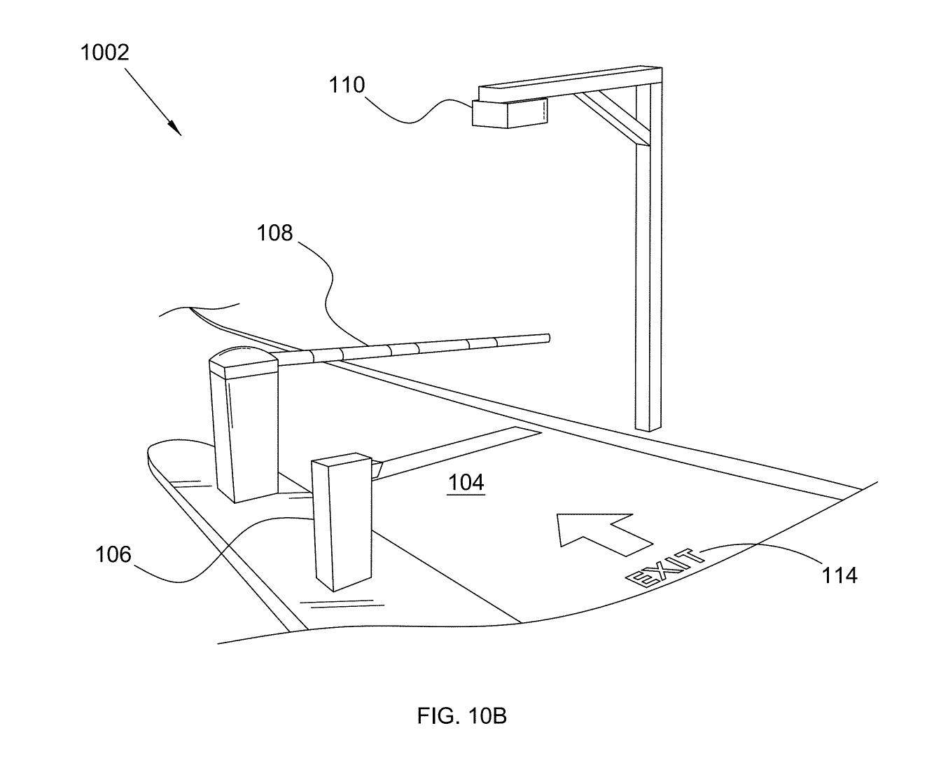

Turning now to FIG. 4, the mobile communication device 116 can download the electronic ticket 120 in addition to the RFID tag 126. An electronic ticket scanning page 400 displays upon entry to the parking area 104. At his page 400, the downloaded electronic ticket 402 is held up in front of the reader at the gate controller 106 for scanning by a mobile phone scanner, or other compatible reader known in the art (see FIGS. 10A, 10B).

Next, the mobile application displays a parking information page 404 that shows the user the location of the parking facility 102, the elapsed time in the parking area 104, and the selected payment method. Upon leaving the parking area 104, the user rescans another downloaded electronic ticket 406 at the reader. The information is processed, including the duration for parking, and the user is charged accordingly. A receipt page 408 is then generated for the user. In other embodiments, the user may also receive a payment verification email with the receipt.

In some embodiments, the system may also provide a parking terminal application. The parking terminal application is located at entries/exits at the gate controller 106. The parking terminal application is used for reading a two-dimensional barcode, e.g., a QR code, using front facing camera, as well as being connected to the NFC reader to transmit and receive data from the backend server. Initial installation required, remote maintenance from then on.

In some embodiments, the system may also provide a Web application that is only accessible to merchants and admins. The Web application is used to view, update, and/or delete data relating to transactions and users. The Web application also provides analytical data generation.

Tuning now to FIG. 5, the software application from the mobile application, the parking terminal application, and the Web application all provide the user with various useful function and menu pages 500 on the mobile device that help elucidate the parking experience and the payment process. A menu page 502 provides the options of: History, Notifications, Payment, Help, About Us, Terms and Conditions, Getting the RFID tag, and Logging Out. A payment page 504 lists the possible methods of payment that are automatically deducted upon leaving the parking area 104. These may include credit card, bank account, PayPal, iPhone payment, and other payment means known in the art.

Continuing with the function and menu pages 500, a selection of a credit card page 506 displays the credit card information provided by the user, including card number, expiration date, and code. The user also has the option of making that credit card the default card for future payments. A payment edit page 508 allows the user to change information about the credit card or other payment means. A historical archive page 510 displays prior parking payments and parking durations. This can help the user manage records more efficiently. An administrator of the parking facility 102 can also better market to the user through use of the historical archive page 510.

Another unique function offered through the software application is the notification page 512. The notification page 512 generates a message that is pertinent to the parking area 104 and the vehicle 114, and then transmits the message to the user's mobile communication device 116 through the software application. The message may include a notification that the payment instrument is not charging correctly, or that the vehicle 114 has stayed in the parking area 104 past a predetermined duration, or that the parking area is full, and thereby the user should avoid the parking facility 102 at that time. Though any message pertinent to parking and the user may be sent through the notification page 512.

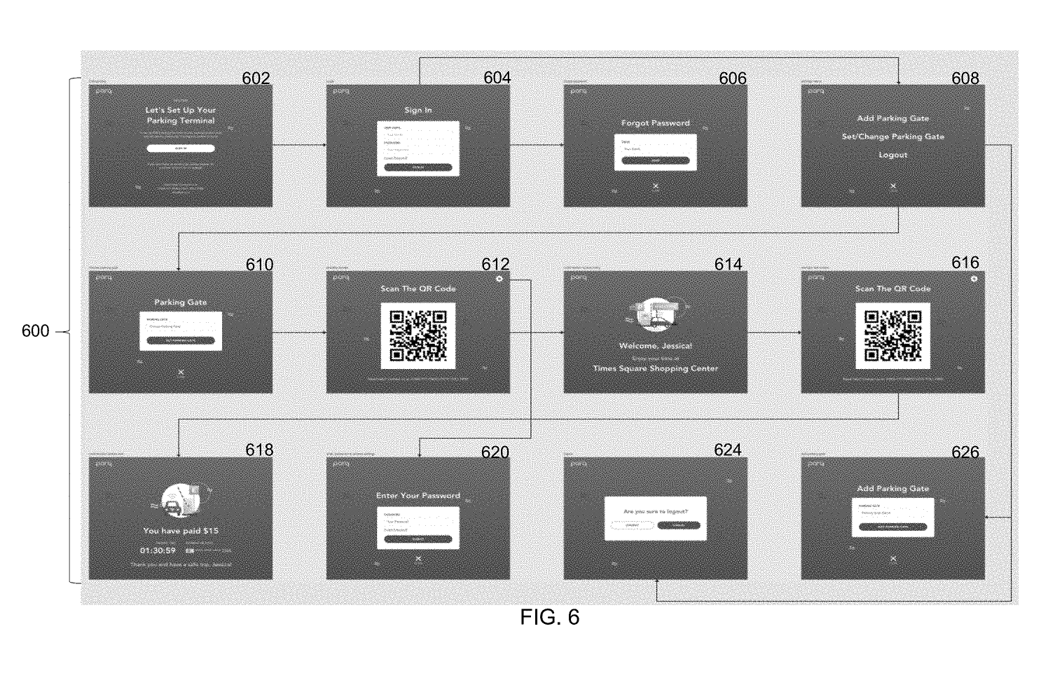

In addition to downloading onto a mobile device, such as a smart phone, the software application can also download onto a tablet 600. The pages and functions provided in the tablet 600 are similar to the aforementioned menus and functions 500 for the app on the mobile device. As FIG. 6 shows, a welcome page 602 greets the potential user, vehicle owner, vehicle operator. This is followed by a sign-in page 604 in which the user signs in. This can include providing a name and password. If the user should forget a password, a password recollection page 606 allows the user to recover the forgotten password. The recovery may be performed through an email or text to the user; whereby the user creates a new password.

Continuing with the tablet software application, a log out options page 608 allows the user to select between: adding an RFID tag 126, editing information about the RFID tag 126, and logging out. If the user selects logging out, a log out page 624 appears. If the user selects to order an RFID tag, a parking gate page 626 appears on the tablet 600 software application.

In some embodiments, a tablet device 600 software application displays a parking gate selection page 610. The parking gate selection page 610 allows the user to choose where to park the vehicle, prior to entering the parking area 104. This menu option reserves a parking spot or parking section for the vehicle in the parking area 104. The tablet 600 also provides a scanning page 612 that displays the electronic ticket 120 or RFID tag 126 correspond to, and display this information upon being scanned by an appropriate reader/scanner. A password request page 620 may appear as a security measure, requesting that the user input the password. This ensures that the correct user is entering the parking area.

Upon scanning the identification, and entering the parking area, a greetings page 614 welcomes the user into the parking area. This is an indication that the user is processed in and the timer has started for calculating payment. In some embodiments, the tablet 600 software application provides a second scan page 616 when the vehicle leaves the parking area 104. Similar to entry, the gate controller reader scans the second scan page 616 and allows the vehicle to exit. Shortly thereafter, a payment confirmation page 618 appears on the tablet. This may include an amount paid and duration of parking information.

The personal and financial information of the vehicle 114 is scanned from the electronic ticket on the user's mobile communication device 116, or on the RFID tag affixed to the windshield of the vehicle. The parking facility server 118 and payment server 122 retrieve this stored information to identify the vehicle 114 through scanning of the electronic ticket 120 or RFID tag 126, as described above.

Based on the personal and financial information of the vehicle 114, an electronic ticket 120, an RFID tag 126, or other digitally displayable data is generated for the vehicle 114. The electronic ticket 120 and RFID tag 126 contain parking related data that correlates to the information provided by the vehicle 114 during registration. In one embodiment, the electronic ticket 120 is based at least partially on the personal and financial information of the vehicle 114, and is displayable on the mobile communication device 116.

In a second embodiment, the RFID 126 is based partially on the personal and financial information of the vehicle 114, and is scanned automatically once near the scanner or reader disposed in proximity to the entrance or exit of the parking facility/garage. For example, the electronic ticket 120 or RFID 126 may include information that represent the type of vehicle driven by the vehicle 114, the parking rate charged to the vehicle 114, and the payment information of the vehicle 114.

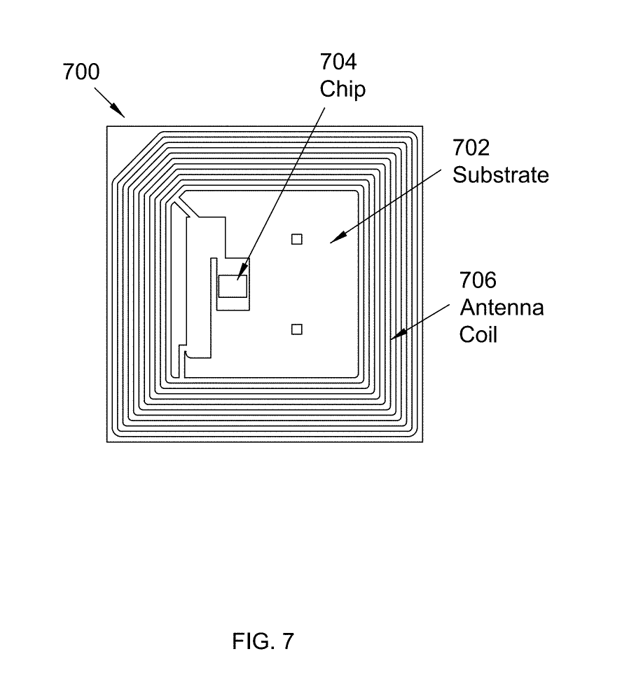

The RFID technology is a separate entity from the electronic ticket 120 generated on the mobile communication device 116, or the Bluetooth networking standard 124. The system 100 implements RFID technology to allow for a frictionless parking experience. Using specialized readers 110 and RFID tags 126 enables seamless ingress and egress of the vehicle 114 through the parking facility 102. FIG. 7 illustrates an exemplary RFID tag 700 that can be affixed directly on the windshield of the vehicle.

As shown in FIG. 7, the RFID device 700 may include a physical transponder such as the one used in toll-payments (e.g., RFID tag 126/Sun Pass device 900). The RFID tag 700 eliminates the need to even have a mobile communication device at hand. The RFID tag 700 may include a substrate 702, such as a sticker, a chip 704 for processing, and an antenna coil 706 that transmits the data from the RFID tag 700. The RFID tag 700 may have an aesthetic appeal. The RFID tag 700 can take many shapes and forms. The most common tend to be stickers and tags due to their small size and effectiveness. Some bigger devices may be needed to encode large amounts of data.

In one possible embodiment, a user purchases the RFID tag 700 and registers their payment information onto it through a company website. Once registered on the website (company database), the user can use the hands-free RFID tag 700 to enter and exit parking facilities in the same way as using the mobile device or Bluetooth networking standard 124. Thus, the hands-free RFID tag 700 communicates with the company database and parking facility readers.

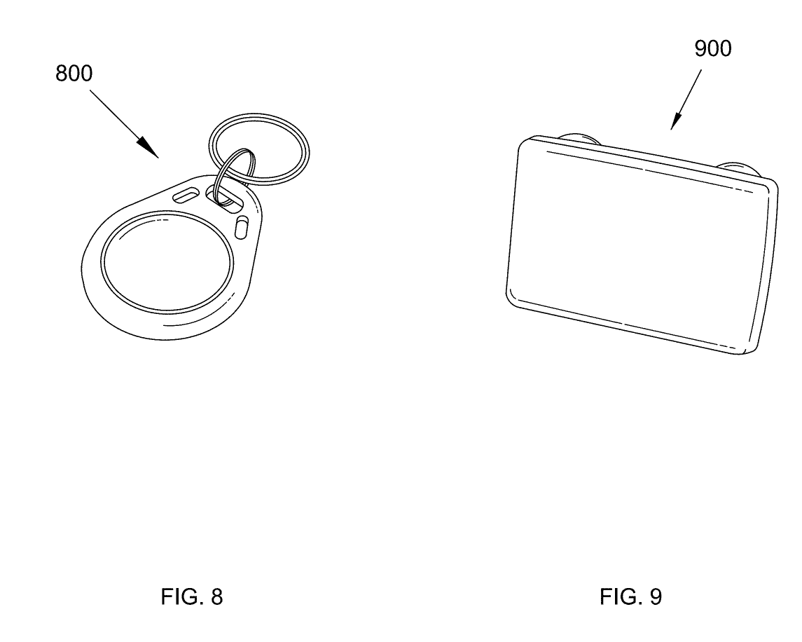

Continuing with the identification means provided by the system 100, FIG. 8 illustrates an RFID fob 800 that is commonly used in residential buildings and vehicle. FIG. 9 illustrates a transponder, or toll-road-style RFID 900 that can attach to the vehicle so that the reader 110 can remotely scan the toll-road-style RFID 900. These are most commonly seen in use for toll-road systems, e.g. Sun Pass transponder 800. These are placed in vehicles using suction cups or Velcro strips to secure the RFID transponder 800 to the windows or dashboard of the vehicle.

Those skilled in the art will recognize that Radio-Frequency Identification, or RFID, is a technology that has been around since the World War II. It has been used for many years in a vast variety of ways. From intercepting radio signals often used in espionage, to store information for vehicle identification or electronic payments, RFID technology has always had a huge potential for innovative applications. It consists of two simple components that either transmit or read information. The tag, or label, transmits information wirelessly using electromagnetic waves for the reader to receive.

RFID can be passive, battery-assisted passive, or fully active. A passive tag is one that does not have an internal power source. They are activated by the electromagnetic energy given off by the reader. A battery-assisted passive tag contains a small battery in it that activates the tag when near a reader. An active tag also has a battery that intermittently sends out its signal to be interpreted by the reader. The receiver, or reader, is a two-wave radio transmitter-receiver that has two classifications. Similar to the tags, the reader can either be passive or active. Passive readers are dormant and are activated only once an active tag emits its signal onto the reader. Active readers transmits interrogator signals to communicate with both passive and active tags. With all these options, there are multiple different ways to set up an RFID system to fit specific needs.

The system 100 connects to a secure server network to record, analyze, and process all of the data. The RFID tag 126 must approach an RFID reader in which payment information is transmitted remotely and automatically to the payment server 122. Each component of the RFID tag 126 will have to be specifically programmed to carry out its own individual task. The components will be described in detail below.

The parking facility 102 comprises a gate controller 106 that regulates access to the parking area 104 with a reader 110 and a deployable gate 108. The reader 110 receives vehicle 114 information from the mobile communication device 116, RFID tag 126, or Bluetooth networking standard 124. The reader 110 processes all information through the gate controller 106 system. The gate 108 is controlled to selectively open and close, so as to regulate vehicle 114 entry and exit to and from the parking area 104.

In some embodiments, the gate controller 106 may be operatively connected to the parking facility server 118. In this manner, the gate controller 106 can be controlled, transmit information, and receive commands for appropriate operation of the gate 108.

FIG. 10A illustrates the vehicle 114 entering the parking area 104 after passing the gate controller 106. This ingress process 1000 allows the vehicle to scan information, be allowed access into the parking area 104, and park the vehicle for a duration. FIG. 10B illustrates the vehicle 114 exiting the parking area 104 waiting for the reader to read the RFID tag 126. This egress process 1002 allows the vehicle to scan information, be allowed to leave the parking area 104. Further, a payment is processed and a receipt is provided when the vehicle 114 egresses.

Looking again at FIG. 1, the gate controller 106 comprises a reader 110 that scans the user's electronic ticket 120 directly from the mobile communication device 116, or in some embodiments, scans the RFID tag 126 from the user's vehicle. The electronic ticket 120 and the RFID device 116 may include, but are not limited to, machine-readable parallel bars that store binary code, matrix dots, and alphanumeric digits. The reader 110 may include, without limitation, an optical scanner, RFID scanner, a machine-readable bar code reader, and a laser reader.

When the reader 110 is active, the reader can detect nearby tags upon entry to facility; the reader 110 creates a time stamp for each individual vehicle 114 upon entry stored on the payment server 122; the reader creates a time stamp upon exit stored on the payment server 122; the payment server 122 calculates elapsed time for each tag; the reader 110 enables the payment server 122 to receive payment information from the mobile communication device 116, RFID tag 126, or Bluetooth networking standard 124 during exit; the reader 110 allows the payment server 122 to calculate required payment for facility use; the reader 110 allows the payment server 122 to charge the provided payment accordingly; and the parking facility server 118 stores all transaction data through a secure company server.

The RFID tag 126 may provide an active tag that can be read by the reader 110. In this embodiment, each tag uniquely identifiable; the parking facility server 122 stores pre-registered private payment information; the parking facility server 122 receives interrogating signals from reader 110 and processes customer information; and the parking facility server 122 is network connected for writing new information (payments) to the device.

Thus, the RFID scanned information is relayed to the parking facility server 118 for verification and to receive further commands. Upon verification from the parking facility server 118, the gate controller 106 actuates the gate 108 to open, and the payment server 122 is initiated to charge the vehicle 114 accordingly. Thus, by directly displaying the electronic ticket 120 or RFID tag 126 to the reader 110 at the gate controller 106, the vehicle 114 is automatically permitted access through the gate 108, and is either automatically charged a predetermined price for accessing the parking area 104 or charged automatically upon exit for the duration in the parking area 104. An automatic payment may be charged upon entrance or exit, depending on the facility.

In this manner of enabling the reader 110 to communicate with; the parking facility server 118, the mobile communication device 116, and the RFID tag 126, the system 100 can accurately regulate the user's access to the parking facility 102, and then charge the vehicle 114 appropriately for access to the parking area 104 directly at the gate 108.

Additional embodiments of the system 100 allow the vehicle 114 to remotely communicate information with the gate controller 106 through a Bluetooth networking standard 124. In this non-limiting embodiment, the gate controller 106 comprises a receiver 112 that is configured to remotely receive the user's information from the mobile communication device 116, or the vehicle.

The received information is then relayed to the parking facility server 118 for verification, similar to the reading of the electronic ticket 120. Through use of the Bluetooth 124, the vehicle 114 passes the gate 108 and pays for access to the parking facility 102 while approaching the gate 108. The vehicle 114 does not have to stop at the gate controller 106 to display the information through the mobile communication device 116, as with the electronic ticket 120.

Additional embodiments of the system 100 allow the vehicle 114 to communicate information with the gate controller 106 through an RFID networking standard. In this non-limiting embodiment, the gate controller 106 comprises a receiver 112 that is configured to remotely receive the user's information from the RFID 126, or the vehicle. The received information is then relayed to the parking facility server 118 for verification, similar to the reading of the electronic ticket 120 or Bluetooth. Through use of the RFID device 126, the vehicle 114 passes the gate 108 and pays for access to the parking facility 102 while approaching the gate 108. The vehicle 114 does not have to stop at the gate controller 106 to display the information through the mobile communication device 116, as with the electronic ticket 120.

It is significant to note that with Bluetooth technology, data signals are wirelessly transmitted to the gate controller 106 to actuate the gate 108 and the payment server 122. Those skilled in the art will recognize that Bluetooth technology transmits a low power radio wave signal containing the vehicle 114 information, the duration of parking, and other pertinent information for enabling access to the parking area 104 and transaction related data.

In one exemplary use of Bluetooth, a data transmitter operatively couples to the mobile communication device 116 or vehicle of the vehicle 114. As the vehicle 114 approaches the gate 108, the transmitter exchanges data with a Bluetooth adapted receiver 112 at the gate controller 106 using short-wavelength UHF radio waves in the ISM band from 2.4 to 2.485 GHz. The gate 108 is then actuated to open or close accordingly. The payment server 122 also charges the vehicle 114 accordingly based on this Bluetooth communication protocol.

In some embodiments, a payment server 122 is in communication with the gate controller 106 and the parking facility server 118. The payment server 122 is configured to authenticate and process payment for the vehicle 114 of the parking facility 102 based, at least partially, on the duration of time in the parking area 104 or the number of times the vehicle 114 accesses the parking area 104. In one embodiment, the payment server 122 communicates with the gate controller 106 and reader 110 to receive the duration of time and the number of times the vehicle 114 access the parking area 104. The payment sever 122 may then calculate the respective charges for the vehicle 114.

Thus, the vehicle 114 can either pay directly at the gate controller 106 with the electronic ticket 120; or pay remotely from the gate controller 106 through use of the RFID networking standard 126 or Bluetooth networking standard 124. In one embodiment, the payment server 122 relays a receipt to the vehicle 114 and to the parking facility server 118 to record the completed parking transaction.

For example, the first hour of parking is $5.00. Each additional hour is $3.00, with a maximum of $25.00 per twenty-four hour period. The vehicle 114 communicates with the gate controller 106 through the electronic ticket 120, RFID tag 126, or Bluetooth networking standard 124. The gate controller 106 transmits vehicle 114 access information to the payment server 122.

The payment server 122 initiates calculating the duration of parking upon the vehicle 114 presenting the electronic ticket 120, RFID tag 126, or Bluetooth networking standard 124 for entry to the gate controller 106, and stops calculations when the vehicle 114 presents the same electronic ticket 120, RFID tag 126, or Bluetooth networking standard 124 to the gate controller 106 for exit. Upon payment, the payment server 122 communicates to the gate controller 106 to open the gate 108. The payment server 122 then initiates the generation of a receipt to the user's mobile communication device 116 and the parking facility server 118 as a record of the transaction.

In another non-limiting embodiment of the payment process, the payment server 122 is configured to receive the user's personal and financial information from the parking facility server 118, and then verify that the vehicle 114 is a registered account holder within the system 100. Upon verification from the payment server 122, the parking facility server 118 is configured to signal the gate controller 106 to open the gate 108 and allow the vehicle 114 to enter the parking area 104.

The gate controller 106 is also configured to detect entry of the vehicle 114 into the parking facility 102 and to provide notification to the parking facility server 118 and the payment server 122 for payment processing. This automated process can be effective during late night operation of the parking facility 102.

Some prior art references for payment servers and processors used in parking facilities include: United States patent 20150025947, which teaches paper ticket 120s or ID tokens in ways that minimize disruption to the existing infrastructure; United States patent 20150332517, which teaches automatic recognition of garage/gate ID, automatic identification of paper ticket ID without optical scanning, and direct payment in manually operated garages, including those using valet parking; and United States patent 20160042575, which teaches a parking facility server located proximate to a parking facility, a central authentication and payment processing server for authenticating and processing payment for a user of parking facilities, a gate controller positioned proximate to a barrier gate at the parking facility, and at least one of an identification module connected to a vehicle, and a user computer device including or accessing an automated parking and payment processing application; whereby the gate controller is configured to receive, via Bluetooth communication with the at least one of an identification module and a user computer device, identification information about a user seeking entry into the parking facility, and to relay the identification information to the parking facility server.

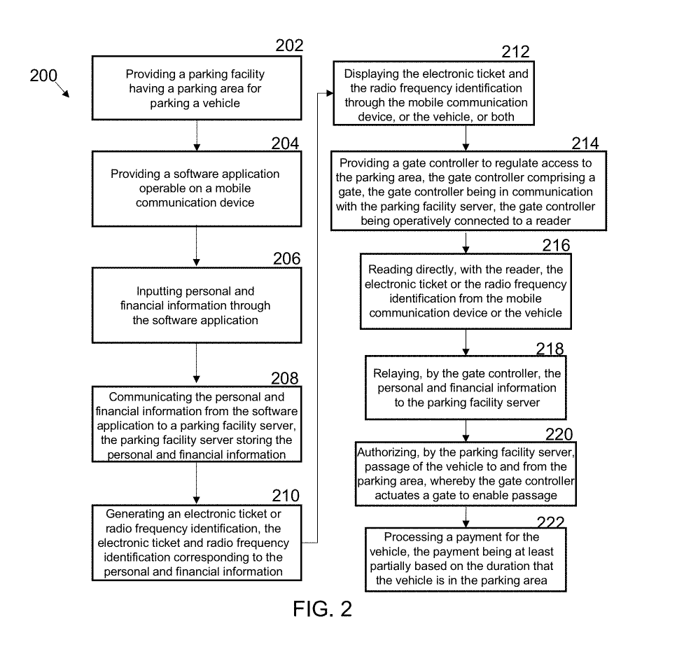

FIG. 2 references a flowchart of an exemplary method 200 for facilitating customer service at a parking facility. The method 200 may include an initial Step 202 of providing a parking facility 102 having a parking area 104 for parking a vehicle 114. The parking facility 102 may include a parking lot or a general area for parking a vehicle or animal, is known in the art. The parking facility 102 has a gate controller 106 that operates a gate 108 for regulating access to and from a parking area 104. A fee is charged for access to the parking area 104; generally payable upon leaving the parking area 104.

The method 200 may further comprise a Step 204 of providing a software application operable on a mobile communication device 116. The software application may include a computer program designed to perform a group of coordinated functions, tasks, or activities for the benefit of the vehicle 114. Software application is downloadable on a mobile communication device 116, such as a smart phone, laptop, or tablet; or accessed through any Internet browser on any desktop, laptop, or mobile browser. FIG. 3-6 references the various pages for a mobile communication device software application 300 and a tablet device software application 600.

A Step 206 includes inputting personal and financial information through the software application. The personal and financial information is used to identify the vehicle 114 for verification, and also to receive payment from the vehicle 114, or operator/owner of the vehicle 114. Standard information known in the art is provided by the vehicle 114 in a pre-registration process.

Thus, upon registration, the vehicle 114 may receive a RFID 126 to apply on the vehicle, or an electronic ticket 120 may be generated for display on the mobile communication device 116. Both operate substantially the same, with only the convenience of one over the other. Also, both identification means may be used simultaneously with the vehicle. In one non-limiting embodiment, the RFID is a Passive High Frequency or an Ultra High Frequency RFID tag. In other embodiments, the RFID and the electronic ticket comprises a two-dimensional barcode, such as a QR code. Though other identification means known in the art may also be used.

Continuing with method 200, a Step 208 teaches communicating the personal and financial information from the software application to a parking facility server 118, the parking facility server 118 storing the personal and financial information. Beyond the aforementioned functions and options of: registering the vehicle and vehicle owner/operator, determining a payment method, receiving pertinent notification messages, collecting marketing information about the vehicle owner/operator, and generally managing parking functions; the software application is in constant communication with servers 118, 122 that store the information and process payments. This communication is important to authorize appropriate entry for the vehicle into the parking area 104, based on the personal and financial information of the user.

The parking facility server 118 is dedicated to the parking facility 102 or a group of parking facilities in a network. The payment server 122 is dedicated to processing payments for the duration of time the vehicle is in the parking area 104. The information communicated with the servers 118, 122 corresponds to the vehicle 114, the owner/operator of the vehicle 114, or an administrator of the parking facility 102. The parking facility server 118 and/or the payment server 122 may include, without limitation, a database, a processor, a network, or a cloud that can store, transmit, receive, and process the information.

In one non-limiting embodiment, the parking facility server 118 hosts and handles all traffic and communication between all system components (mobile app, parking terminal, parking gate). The parking facility server 118 is also configured to gather real-time dynamic payment information inputted by the user to be digitally transferred from the secure storage database to the parking terminal. The parking facility server 118 is also configured to control the deployable gate 108 at the gate controller 106 for entry/exit upon payment validation.

In an alternative embodiment of the method 200, an additional step may include providing a payment server 122, the payment server being in communication with the parking facility server 118. The payment server is in communication with the parking facility server 118. However, the payment server 122 is configured to calculate costs for the duration in the parking facility, and to receive and process preferred payment types. The payment server 122 may include, without limitation, a cloud, a server, a database, a network, and a processor.

Yet another alternative step may include storing the personal and financial information in a remote database. The remote database is also in communication with the parking facility server 118 and the payment server. However, the remote database may be encrypted, providing greater security for personal and financial information. The remote database may also be used by an administrator of the parking facility 102 for marketing purposes. The remote database requires transactional database activities and transfer/update of information.

A Step 210 includes generating an electronic ticket 120 or a radio frequency identification 126, the electronic ticket and the radio frequency identification corresponding to the personal and financial information. The electronic ticket 120 is a digital display that is readable by a scanner 110, and is representative of the provided vehicle 114 information, and the vehicle 114 activity in the parking facility 102. FIG. 4 shows the mobile communication device 116 with a downloaded electronic ticket 120.

The RFID tag also corresponds to the information of the vehicle. However, RFID tag 126 is affixed directly to the vehicle windshield; whereby the user does not have to hold the mobile communication device towards the reader when driving through the gate controller. RFID tag 126 is readable by the scanner 110 when in close proximity to it.

As shown in FIG. 7, the RFID device 700 may include a physical transponder such as the one used in toll-payments (e.g., RFID tag 126/Sun Pass device 900). The RFID tag 700 eliminates the need to even have a mobile communication device at hand. The RFID tag 700 may include a substrate 702, such as a sticker, a chip 704 for processing, and an antenna coil 706 that transmits the data from the RFID tag 700. In one non-limiting embodiment, the RFID comprises a Vulcan RFID Custom Windshield Tag. Though other RFID technologies may also be used.

In some embodiments, a Step 212 may include displaying the electronic ticket and the radio frequency identification through the mobile communication device, or the vehicle, or both. As the vehicle passes through the gate controller 106, a reader 110, such as a mobile phone scanner and an RFID scanner, are oriented towards the vehicle 114, so as to read the pertinent identification. The mobile communication device 116 can be held up to the mobile phone scanner, and the RFID on the windshield of the vehicle is automatically scanned by the RFID scanner. The gate 108 is then actuated to open upon transfer of information for the vehicle, and payment confirmation.

A Step 214 comprises providing a gate controller 106 to regulate access to the parking area, the gate controller comprising a gate 108, the gate controller 106 being in communication with the parking facility server, the gate controller being operatively connected to a reader 110, the reader being operable to read the electronic ticket and the radio frequency identification. The gate 108 may include a bar that pivotally moves up and down to regulate access to the parking area 104. However any type of gate 108, barrier, or wall that regulates access to an area defined for parking may be used. The gate controller 106 comprises a receiver 112, a reader 110, a transmitter, and a motor and gear device for actuating the gate 108.

A Step 216 comprises reading directly, with the reader 110, the electronic ticket 120 or the radio frequency identification 126 from the mobile communication device or the vehicle. The reader 110 may include an optical scanner barcode reader 110 or an RFID reader known in the art. The reader and/or the mobile commutation device may be NFC-enabled, so as to create a more efficient transfer of data therebetween. This NFC functionality is used for the software application to scan/detect RFID tag; and also used to upload payment information to the user RFID tag. To perform both cases above, NFC-enabled mobile communication devices utilize a quality camera.

In one non-limiting embodiment, the mobile communication device 116 is an Android tablet with NFC functionality for the entry and exit parking terminal, with stable Wi-Fi or 3G/4G LTE connection. The Android application running on the tablet enables both scanning of a two-dimensional barcode, e.g., a QR code, and NFC high range scanner. Upon scanning the two-dimensional barcode or the RFID tag, the Android application connects to the backend server to validate the user's request to open/close parking gate accordingly. The reader 110 may have a front facing camera for reading the two-dimensional barcode on the vehicle or mobile communication device.

The method 200 may also include a Step 218 of relaying, by the gate controller 106, the personal and financial information to the parking facility server 118. The information is relayed wirelessly. In some embodiments the vehicle 114 information may be encrypted to provide additional security. NFC technology or a Bluetooth network standard 124 may be used to transfer the information.

Another Step 220 includes authorizing, by the parking facility server, passage of the vehicle 114 to and from the parking area, whereby the gate controller actuates a gate to enable passage. The gate may include an arm that raises and lowers to enable passage of the vehicle 114. The gate controller 106 actuates the gate 108, after receiving instructions from the servers 118, 122.

A final Step 222 includes processing a payment for the vehicle 114, the payment being at least partially based on the duration that the vehicle is in the parking area 104. The payment may also be based on the actuation of the gate 108 by the gate controller 106. A payment receipt is generated for the vehicle. The receipt may include the amount paid, the type of payment instrument, and the duration in the parking area 104. The payment is fully automated, and based on the financial information provided during registration Step 106.

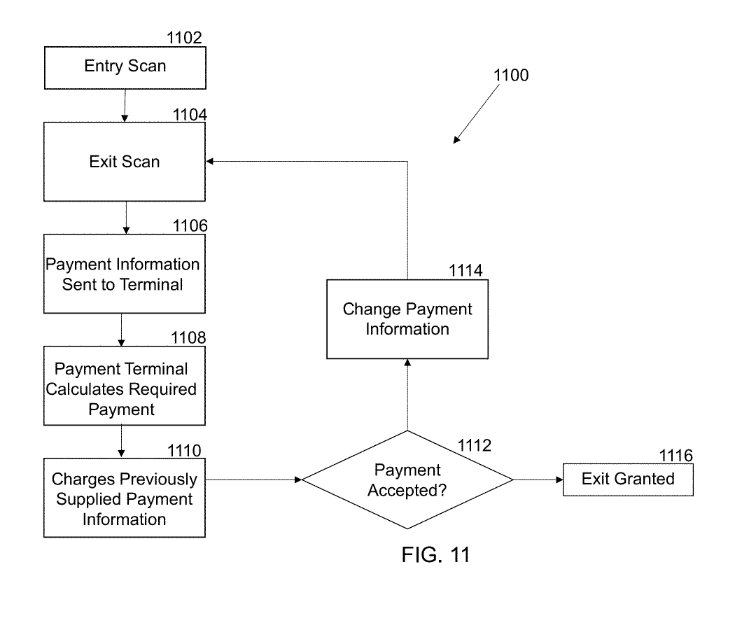

FIG. 11 references a flowchart of an alternative method 1100 for the payment process at a parking facility 102. The method 1100 may include an initial step 1102 of generating an entry scan. This is performed at the gate controller 106 by the reader 110. Another step 1104 includes generating an exit scan. Another step 1106 includes transmitting payment information to the terminal, and payment server 122. The payment server utilizes stored financial information associated with the scanned vehicle 114 to calculate appropriate charges.

In some embodiments of method 1100, a Step 1108 includes calculating the payment with the payment server 122. The payment is determined by the duration of time the vehicle is in the parking area 104. A Step 1110 may include providing previous charges. A payment option 1112 demands that if the payment is not accepted, a Step 1114 includes changing the payment information. The user can edit payment changes directly through the software application on the communication device 116. However, if the payment is accepted, a Step 1116 includes granting the vehicle exit by opening the gate 108.

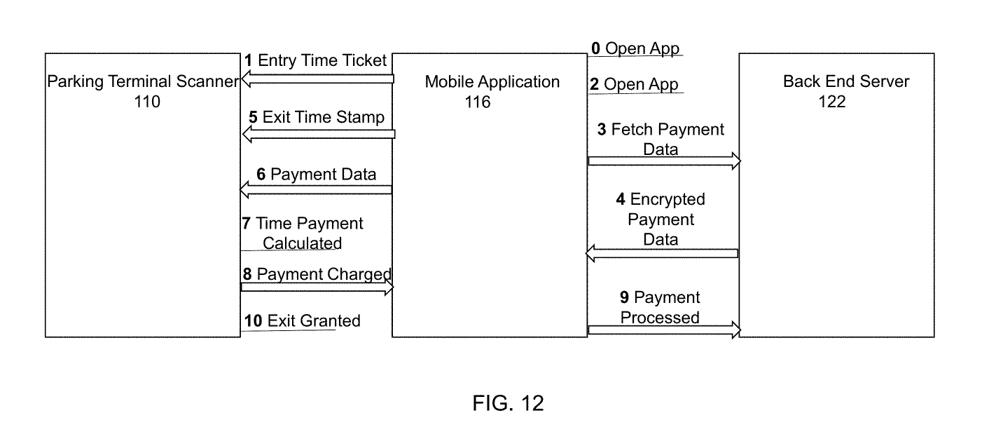

FIG. 12 references a block diagram 1200 for a process that involves communication between a reader 110, an electronic ticket 120 that is displayed on a mobile communication device 116, and a payment server 122. The diagram 1200 includes opening the application on a mobile communication device 116, such as a smart phone. An electronic ticket 120, corresponding to the provided information displays. The reader scans the electronic ticket, and determined the duration of parking by the vehicle 114. The payment data is fetched from the payment server 122. The next step includes sending encrypted payment data. The next step includes providing an exit stamp (receipt) from the gate controller 106 in the parking area 104. Then, the payment data and the time/payment are calculated and sent to the payment server 122. The payment is then charged, processed, and the vehicle is allowed to exit the parking area 104.

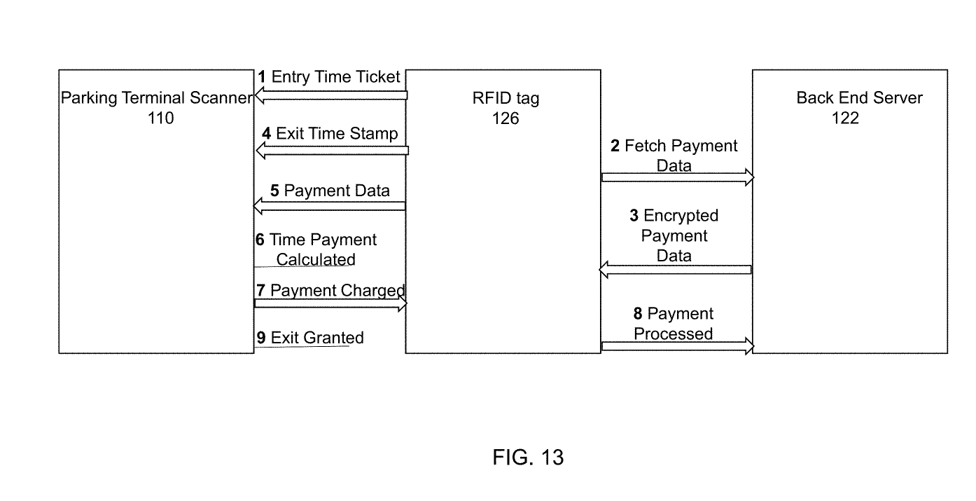

FIG. 13 references a block diagram 1300 showing an alternative relationship between a reader 110, an RFID tag 126, and a payment server 122. It is significant to note that diagram 1300 is similar to diagram 1200, except that RFID tag 126 is scanned, rather than an electronic ticket 120 directly from mobile communication device 116. Diagram 1300 comprises a process of receiving an entry time ticket upon scanning the RFID tag 126. The payment data is fetched from the payment server 122. The next step includes sending encrypted payment data. The next step includes providing an exit stamp from the parking area upon RFID scan.

Next, the payment data and the time/payment are transmitted to, and calculated by the payment server 122. The payment is then charged, processed, and the vehicle 114 is allowed to exit the parking area 104. In an alternative embodiment of the method 200, an additional step may include displaying, by the software application, a historical archive of prior parking payments and parking durations. The historical archive shows past parking experiences, including durations and payments. This can also be viewed by an administrator to help manage the parking facility 102 or market to the user.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

What is claimed is:

1. A computer-implemented method for facilitating access and payments to a parking facility, the method comprising:
providing a parking facility having a parking area for parking a vehicle;
providing a software application operable on a mobile communication device;
inputting personal and financial information through the software application;
communicating the personal and financial information from the software application to a parking facility server, the parking facility server storing the personal and financial information;
generating an electronic ticket or a radio frequency identification, the electronic ticket and the radio frequency identification corresponding to the personal and financial information;
displaying the electronic ticket and the radio frequency identification through at least one of the mobile communication device and the vehicle;
providing a gate controller to regulate access to the parking area, the gate controller comprising a gate, the gate controller being in communication with the parking facility server, the gate controller being operatively connected to a reader, the reader being operable to read the electronic ticket and the radio frequency identification;
reading directly, with the reader, the electronic ticket or the radio frequency identification from the mobile communication device or the vehicle;
relaying, by the gate controller, the personal and financial information to the parking facility server;
authorizing, by the parking facility server, passage of the vehicle to and from the parking area, whereby the gate controller actuates a gate to enable passage; and
processing a payment for the vehicle, the payment being at least partially based on the duration that the vehicle is in the parking area.

2. The method of claim 1, further comprising a step of providing a payment server, the payment server being in communication with the parking facility server.

3. The method of claim 2, wherein the step of processing the payment, further comprises, processing, with the payment server, a payment for the duration in the parking area, the payment based at least partially on the duration that the vehicle is in the parking area and actuation of the gate by the gate controller.

4. The method of claim 3, further comprising a step of storing the personal and financial information in a remote database.

5. The method of claim 1, further comprising a step of registering a user through the software application, the registration including providing contact information, vehicle type, payment preferences, and a password.

6. The method of claim 1, further comprising a step of displaying, by the software application, a historical archive of prior parking payments and parking durations.

7. The method of claim 1, wherein the electronic ticket and the radio frequency identification comprises a two-dimensional barcode for reading by the reader.

8. The method of claim 1, wherein the reader is a scanner.

9. The method of claim 1, wherein the reader comprises an NFC reader.

10. The method of claim 1, wherein the mobile communication device is an NFC-enabled mobile communication device.

11. The method of claim 1, wherein the mobile communication device includes at least one of the following: a smart phone, a tablet, a laptop, and a computer.

12. The method of claim 1, wherein the parking facility server includes at least one of the following: a cloud, a server, a database, a network, and a processor.

13. The method of claim 1, wherein the radio frequency identification is a Passive High Frequency or an Ultra High Frequency RFID tag.

14. A computer-implemented method for facilitating access and payments to a parking facility, the method consisting of:
providing a parking facility having a parking area for parking a vehicle;
providing a software application operable on a mobile communication device;
registering a user through the software application, the registration including providing contact information, vehicle type, payment preferences, and a password;
inputting personal and financial information through the software application;
communicating the personal and financial information from the software application to a parking facility server, the parking facility server storing the personal and financial information;
providing a payment server, the payment server being in communication with the parking facility server;
generating an electronic ticket or a radio frequency identification, the electronic ticket and the radio frequency identification corresponding to the personal and financial information;
displaying the electronic ticket and the radio frequency identification on the mobile communication device, or the vehicle, or both;
providing a gate controller to regulate access to the parking area, the gate controller comprising a gate, the gate controller being in communication with the parking facility server, the gate controller being operatively connected to a reader, the reader being operable to read the electronic ticket and the radio frequency identification;
reading directly, with the reader, the electronic ticket or the radio frequency identification through the mobile communication device or the vehicle;
relaying, by the gate controller, the personal and financial information to the parking facility server;
authorizing, by the parking facility server, passage of the vehicle to and from the parking area, whereby the gate controller actuates a gate to enable passage;
processing, with the payment server, a payment for the duration in the parking area, the payment based at least partially on the duration that the vehicle is in the parking area and actuation of the gate by the gate controller; and
displaying, by the software application, a historical archive of prior parking payments and parking durations.

15. The method of claim 14, wherein the reader comprises an NFC reader.

16. The method of claim 14, wherein the mobile communication device is an NFC-enabled mobile communication device.

17. The method of claim 14, wherein the radio frequency identification is a Passive High Frequency or an Ultra High Frequency RFID tag.

18. A computer-implemented system for facilitating access and payments to a parking facility, the system comprising:
a parking facility comprising a parking area for a vehicle;
a mobile communication device comprising a software application, the software application enabling the input of personal and financial information;
a parking facility server in communication with the software application and the parking facility, the parking facility server storing the personal and financial information of the user;
an electronic ticket or a radio frequency identification corresponding to the personal and financial information, the electronic ticket and the radio frequency identification displayable on the mobile communication device, or the vehicle, or both;
a gate controller regulating a gate for access to the parking area, the gate controller being in communication with the mobile communication and radio frequency identification device and the parking facility server, the gate controller comprising a reader for directly reading the electronic ticket and the radio frequency identification, whereby the parking facility server verifies the personal and financial information; and
a payment server in communication with the gate controller and the parking facility server, the payment server authenticating and processing payment for the user for use of the parking facility, whereby the duration in the parking area determines the payment amount.

19. The system of claim 18, wherein the radio frequency identification is a Passive High Frequency or an Ultra High Frequency RFID tag.

20. The system of claim 18, wherein the reader and the mobile communication device are NFC-enabled.
